(19) United States
(12) Patent Application Publication
(10) Pub. No.: US 2010/0291312 A1
(43) Pub. Date: Nov. 18, 2010

(54) ELECTROLESS PLATING METHOD FOR ALLOY COATING FILM AND PLATING LIQUID

(75) Inventors: Hideyuki Murakami, Ibaraki (JP); Yukio Matsubara, Ibaraki (JP); Syunsuke Moriizumi, Ibaraki (JP); Hiromichi Murakami, Ibaraki (JP); Mikiyo Yoshida, Ibaraki (JP)

Correspondence Address: WENDEROTH, LIND & PONACK, L.L.P., 1030 15th Street, N.W.,, Suite 400 East, Washington, DC, 20005-1503, US

(73) Assignee: National Institute for Materials Science

(21) Appl. No.: 12/734,293

(22) PCT Filed: Oct. 22, 2008
(86) PCT No.: PCT/JP2008/069161

§ 371 Date: Jul. 26, 2010

(30) Foreign Application Priority Data
Oct. 22, 2007 (JP) 2007-273948

(51) Int. Cl. B05D 1/18; C23C 18/48

(52) U.S. Cl. 427/443.1; 106/1.22

(57) ABSTRACT

A substrate is immersed in a metal compound solution prepared by dissolving a plurality of metal compounds of metals differing from each other, to thereby form an alloy film having a desired alloy composition on the surface of the substrate.

### TECHNICAL ART

The present invention relates to an electroless plating method for alloy coating film, comprising contacting a substrate with a solution of metal compounds and reducing the compounds to thereby deposit the metals on the surface of the substrate, and to a plating liquid to be used for it.

### BACKGROUND ART

A technique of coating with a metal film of platinum or the like is applied in various fields of antioxidation coating, electrode materials for various sensors, jewelry, etc. Recently, a technique of coating with an alloy of platinum and iridium for improving mechanical strength and corrosion resistance at high temperature has become specifically noted.

As such an alloy coating method, there are known a sputtering method, a vacuum vapor deposition method and the like, in which, however, the yield is low and which are expensive. Also known is an electrolytic plating method as a method for forming an alloy film of platinum and iridium (Patent References 1 to 3); however, the electrolytic plating method has a limitation in that the surface of the substrate is limited to a conductor.

As a method for solving the problem with the electrolytic plating method, an electroless plating method may be taken into consideration. Heretofore known is plating with a single elementary metal such as platinum or iridium (Patent References 4, 5); however, electroless plating with an alloy is not proposed.

This is because, in the common practice, it has been considered difficult to attain alloy deposition by electroless plating in a desired ratio of different types of metals each having a different reduction potential.

### [Patent Reference 1] JP-A 9-256189

### [Patent Reference 2] JP-A 10-237686

### [Patent Reference 3] JP-A 2005-105299

### [Patent Reference 4] JP-A 2003-105579

### [Patent Reference 5] JP-A 2007-107021

### DISCLOSURE OF THE INVENTION

### Problems that the Invention is to Solve

An object of the present invention is to defy the common wisdom as above and to provide a coating method with an alloy of plural different types of metals such as platinum, iridium and the like by electroless plating.

### Means for Solving the Problems

The electroless plating method of the invention 1 is characterized in that a substrate is immersed in a metal compound solution prepared by dissolving a plurality of metal compounds of metals differing from each other, and an alloy film of the metals is formed on the surface of the substrate.

The invention 2 is characterized in that, in the electroless plating method of the invention 1, the pH value of the metal compound solution is lower than 5.0.

The invention 3 is characterized in that, in the electroless plating method of the invention 1 or 2, one or more of bromides, chlorides, sulfates, citric acid or its salts, oxalic acid or its salts, acetic acid or its salts, and malonic acid or its salts are mixed in the metal compound solution.

The invention 4 is an electroless plating method, wherein the plurality of metal compounds of metals differing from each other are compounds of Pt and Ir optionally further with compounds of one or more metals of Co, Ni, Cr, Fe and Cu.

The invention 5 is characterized in that at least one of alkali metal bromides or sulfates is mixed in the solution of metal compounds dissolved therein.

The invention 6 is characterized in that at least one of citric acid, oxalic acid and their salts is mixed in the solution of metal compounds dissolved therein.

Provided is a plating liquid for use in the electroless plating method of inventions 1 to 6, which is characterized in that a plurality of metal compounds of metals differing from each other are dissolved therein.

### ADVANTAGE OF THE INVENTION

The invention has enabled not only electroless plating with an alloy film having a desired alloy composition but also forming the alloy during a plating process without previously forming it.

As a result, it has become possible to form an alloy film suitable to the substrate and the intended use thereof by controlling the metals to be used and their proportion in a simple electroless plating method.

According to the invention, it has become possible to form a film of an alloy of platinum/iridium that has been specifically noted these days, and further a film of a binary or more polynary element alloy thereof as combined with any other metal element such as cobalt, nickel or the like, in a simple electroless plating method.

### BRIEF DESCRIPTION OF THE DRAWINGS

FIG. 1 This is a photograph showing the film obtained in Experiment No. 37.

FIG. 2 This is a photograph showing the film obtained in Experiment No. 3.

### BEST MODE FOR CARRYING OUT THE INVENTION

An electroless plating method includes the following three main types.

1) A method to be carried out with adding a reducing agent to a plating liquid (the reducing agent includes, for example, boron hydride, hydrazine, formic acid, or a metal of Zn, Al, Fe or the like).
2) Self-decomposition type.
3) Substitution type.

The electroless plating method of the invention is the substitution type 3), in which a substrate to be plated is put into a plating liquid and the ionized metals in the plating liquid are electrolessly deposited through substitution reduction on the whole or a part of the surface of the substrate. The most characteristic feature of the invention resides in the plating liquid for electrolessly forming a multi-element alloy film.

The plating liquid of the invention indispensably contains a plurality of metal compounds of metals differing from each other. “Metal” in this case is essentially the constitutive element of an alloy to be formed by electroless plating. For the combination of the plurality of “metals” differing from each other, the metals capable of forming an alloy film are selected.

For example, in case where a film of an alloy of platinum (Pt) and iridium (Ir), or an alloy of Pt—Ir—X (X is at least one of Co, Ni, Cr, Fe and Cu) is formed by electroless plating as in Examples given below, the following may be favorably taken into consideration.

1) A water-soluble iridium compound is a typical iridium (Ir) compound, and it includes iridium bromide or iridium chloride. The iridium valence is preferably +3. For example, the iridium concentration in the plating liquid may be at least 1 g/L that satisfies the deposition film amount. Its uppermost limit is not defined, but for example, 10 g/L or more is not always necessary from the viewpoint of the cost.

2) A chloroplatinate salt may be used as a soluble platinum compound, but a sulfate salt and a nitrite salt may also be used. For example, the concentration in the plating liquid may be at least 1 g/L. For example, it may be 10 g/L or less, but from the viewpoint of the cost, it is preferably up to at most 5 g/L.

3) Cobalt is typical as the other alloying metal than iridium and platinum, but nickel, chromium, iron, copper and gold may also be used. For example, the soluble cobalt salt includes chlorides and sulfates, and its concentration in the plating liquid is preferably from 0 to 10 g/L.

In the invention of electroless plating where plural types of metal compounds, for example, those mentioned above are contained in a plating liquid, at least one of bromides, chlorides and sulfates is preferably added to the plating liquid, from the viewpoint that the whole or a part of the surface of the substrate to be plated is dissolved in the plating liquid so as to make the metal ions in the plating liquid effectively deposited through substitution reduction. For example, in forming the above-mentioned Pt—Ir—Pt—Ir—X alloy film, a bromide or a sulfate of an alkali metal, especially bromides or sulfates of sodium is preferably used. For example, the bromide concentration in the plating liquid is preferably from 0.1 to 1 M. When less than 0.1 M, the stability of the plating liquid may be poor; but when more than 1 M, the deposition rate may lower. The sulfate concentration in the plating liquid is preferably at most 1 M, more preferably at most 0.5 M.

For stabilizing the atomic valence of the metal ions in the plating liquid, preferably added is citric acid, oxalic acid or their salt. Acetic acid, malonic acid or their salts are also usable. For example, for the above-mentioned Pt—Ir alloy film or the Pt—Ir—X alloy film, the acid or the like may be added in a concentration of from 0 to 1 M, preferably from 0.1 to 0.5 M. In case where citric acid is added, its amount to be added is preferably within a range of from 0.1 to 100 g/L.

In the electroless plating method of the invention, the pH of the plating liquid is preferably at most 5; and further for the above-mentioned Pt—Ir alloy, it is preferably from 0.4 to 2.0. When the pH is 0.0 or less, the acid concentration is too high and the dissolution of the material increases; but when the pH is more than 5.0, the plating liquid is unstable.

The plating liquid temperature for the Pt—Ir-base alloy may be from 70 to 92° C., preferably from 70 to 80° C. When lower than 70° C., the alloy deposition speed is low; but when higher than 92° C., the plating liquid evaporates too much and such is uneconomical.

The plating time may be defined for attaining the desired plating thickness; and from the film properties, it is preferably from 10 to 120 minutes.

The type of the substrate to be plated is not specifically defined; however, from the viewpoint of metal deposition on the surface of the substrate through substitution of the substrate surface with the metal ions in the plating liquid, preferred is an Ni plate, an Ni-base substrate of an Ni-base single-crystal superalloy or the like, or an Ni-base substrate pretreated by Ni strike plating or Au strike plating, as in Examples shown below. Also, a substrate coated with NI may be used. For example, also employable are ceramics processed by Ni strike plating or additionally by Au strike plating. When such an Ni-base substrate or an Ni-coated substrate is immersed in the plating liquid of the invention, Ni is substituted with the metal ion in the plating liquid whereby an alloy film of metals is favorably formed on the surface of the substrate.

Plating with the plating liquid composition under the plating condition mentioned above has enabled, for example, the following.

(1) By adding a soluble metal salt, electroless alloy plating with Pt—Ir—X (X═Ni, Cr, Co, Fe, Cu) is possible.

(2) The Ir content can be controlled between 8 and 34 wt %.

In addition of PtIr, the inventors have succeeded in incorporation of Co in an amount of up to 4 wt %.

Concrete contents of an experiment for an example of a platinum and iridium alloy are described below. Needless to say, the invention is not limited to this, but can be used in forming any, alloy film of two or more types of metals, as obvious from the following examples and experimental examples.

### EXAMPLES

1. IrBr₃ (1 g/L, Ir equivalent), H₂PtCl₄ (5 g/L, Pt equivalent), NaBr and Na₂SO₄ (each 0.5 M), and citric acid (20 g/L) were added to the distilled water, and its pH was controlled to be 1.12, thereby preparing a plating liquid.

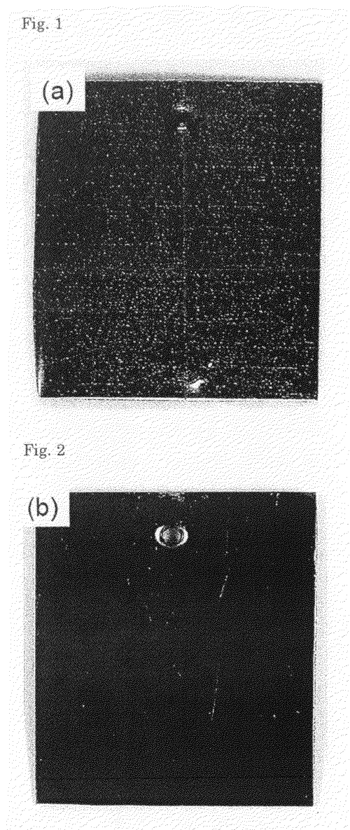

A gold-strike-plated Ni plate (20 mm×20 mm×0.1 mm) was immersed in this liquid, and kept therein for 30 minutes, whereby a film of 12.9 wt % Ir-87.1 wt % Pt was deposited in a thickness of 3.5 μm (FIG. 1). As in the photograph, the film was good, not peeling from the substrate (see Experiment No. 37 in Table 2).

2. Similarly, IrBr₃ (2 g/L, Ir equivalent), H₂PtCl₄ (2 g/L, Pt equivalent), CoCl₂ (3 g/L, Co equivalent), NaBr and Na₂SO₄ (each 0.5 M), and citric acid (20 g/L) were added to distilled water, and its pH was controlled to be 0.74, thereby preparing a plating liquid. A gold-strike-plated Ni plate (20 mm×20 mm×0.1 mm) was immersed in this liquid, and kept therein for 10 minutes, whereby a film of 14.8 wt % Ir-81.0 wt % Pt-4.3 wt % Co was deposited in a thickness of 0.2 μm (FIG. 2). As in the photograph, the film was glossy and good, not peeling from the substrate (see Experiment No. 3 in Table 2).

3. Similarly, a lot of experiments were carried out as in the following Tables 1 to 4 whereby the invention was confirmed.

In Table 2, “Ir/(Ir+Pt+Co)” means an existing ratio of the Ir ion to the total amount of the ions Ir+Pt (+Co) contained in the plating liquid.

Similarly in Table 2, “Ni” in the item of “Substrate and Pretreatment” means that an Ni plate was used as the substrate; and “Ni*” means that an Ni-base single-crystal superalloy was used as the substrate. “Au—St” means that the substrate was pretreated by Au strike plating (in a thickness of at most 0.1 μm). “Au—St thick” means that the substrate was Au strike-plated thicker (0.2 μm). “Ni-x μm” means that the substrate was Ni-plated to a thickness of x μm, Accordingly, “Ni+Au—St” means that the Ni substrate was Au strike-plated (to a thickness of at most 0.1 μm); and “Ni+Au—St thick” means that the Ni substrate was Au strike-plated thicker (0.2 μm). “Ni*+Ni-x μm” means that the Ni-base supper alloy was Ni-plated to a thickness of x μm.

In Table 2, “surface area (dm²)” is the value derived by actually measuring each side of the substrate with a micrometer and a slide caliper.

(1), (2) and (3) in Table 3 show the data of the Pt, Ir and Co content (wt %) in the film analyzed with an X-ray fluorescence spectrometer. These clarify the alloy deposition according to the present method. (4) shows the thickness of the plating film, similarly as derived with an X-ray fluorescence spectrometer, and its unit is μm. “Determination” shows the result of surface observation by visual check or microscopy.

TABLE 1
Liquid Composition and Test Condition

| | | | | | Numbering |
|---|---|---|---|---|---|
| | | Chemical Formula | Concentration | Unit | in Table 2 |
| Liquid | Ir Source | IrBr₃ | 1-10 | g/L (Ir equivalent) | (1) |
| Composition | Pt Source | H₂PtCl₄ | 2-5 | g/L (Pt equivalent) | (2) |
| | Co Source | CoCl₂ | 0-10 | g/L (Co equivalent) | (3) |
| | Salt | NaBr | 0-0.5 | M | (4) |
| | | Na₂SO₄ | 0-1.4 | M | (5) |
| | Additive | Citric Acid | 0-100 | g/L | (6) |
| | | Oxalic Acid | 0-0.5 | M | (7) |
| | | Sodium Dihydrogen | 0-0.3 | M | (8) |
| | | Citrate | | | |
| PH | | | 0.4-1.26 | | (9) |
| Temperature | | | 7-8 | ×10° C. | (10) |
| Time | | | ⅙-2 | hr | (11) |

| | |
|---|---|
| Substrate | Ni, Ni-base Single-crystal Superalloy |

TABLE 2
Electroless Pt—Ir—Co Alloy Plating Test Result
Test Condition

| Experiment | | | | Ir/(Ir + Pt + | | | | | | | | | Substrate and | Surface |
|---|---|---|---|---|---|---|---|---|---|---|---|---|---|---|
| No. | (1) | (2) | (3) | Co) mol % | (4) | (5) | (6) | (7) | (8) | (9) | (10) | (11) | Pretreatment | Area dm² |
| 1 | 1 | 5 | 5 | 9.1 | 0.5 | 0.5 | 20.0 | 0.0 | 0.0 | 1.12 | 8 | ⅙ | Ni + Au-st thick | 0.1 |
| 2 | 1 | 5 | 5 | 9.1 | 0.5 | 0.5 | 20.0 | 0.0 | 0.0 | 1.12 | 8 | ½ | Ni + Au-st thick | 0.1 |
| 3 | 2 | 2 | 3 | 28.6 | 0.5 | 0.5 | 20.0 | 0.0 | 0.0 | 0.74 | 8 | ⅙ | Ni + Au-st thick | 0.1 |
| 4 | 2 | 2 | 2 | 33.3 | 0.5 | 0.5 | 20.0 | 0.0 | 0.0 | 0.74 | 8 | ⅙ | Ni + Au-st thick | 0.1 |
| 5 | 2 | 2 | 2 | 33.3 | 0.5 | 0.5 | 100.0 | 0.0 | 0.0 | 0.90 | 8 | ½ | Ni + Au-st | 0.1 |
| 6 | 2 | 2 | 1 | 40.0 | 0.5 | 0.5 | 20.0 | 0.0 | 0.0 | 0.74 | 8 | ⅙ | Ni + Au-st thick | 0.1 |
| 7 | 5 | 5 | 5 | 33.3 | 0.5 | 0.0 | 20.0 | 0.0 | 0.0 | 0.98 | 8 | ⅙ | Ni + Au-st | 0.1 |
| 8 | 2.5 | 3 | 1.5 | 35.7 | 0.5 | 0.5 | 0.0 | 0.0 | 0.0 | 1.06 | 8 | ⅙ | Ni plate | 0.1 |
| 9 | 2.5 | 2 | 2.5 | 35.7 | 0.5 | 0.5 | 0.0 | 0.0 | 0.0 | 1.06 | 8 | ⅙ | Ni plate | 0.1 |
| 10 | 5 | 5 | 5 | 33.3 | 0.5 | 0.5 | 20.0 | 0.0 | 0.0 | 0.75 | 8 | 1 | Ni* | 0.12 |
| 11 | 5 | 5 | 3 | 38.5 | 0.5 | 0.5 | 0.0 | 0.0 | 0.0 | 1.06 | 8 | ⅙ | Ni + Au-st | 0.1 |
| 12 | 2.5 | 2 | 1 | 45.5 | 0.5 | 0.5 | 0.0 | 0.0 | 0.0 | 1.06 | 8 | ⅙ | Ni + Au-st | 0.1 |
| 13 | 2.5 | 3 | 0.5 | 41.7 | 0.5 | 0.5 | 0.0 | 0.0 | 0.0 | 1.26 | 8 | ⅙ | Ni plate | 0.1 |
| 14 | 2.5 | 2 | 1.5 | 41.7 | 0.5 | 0.5 | 0.0 | 0.0 | 0.0 | 1.06 | 8 | ⅙ | Ni plate | 0.1 |
| 15 | 2 | 2 | 2 | 33.3 | 0.5 | 0.5 | 20.0 | 0.0 | 0.0 | 0.90 | 8 | ½ | Ni + Au-st | 0.1 |
| 16 | 5 | 5 | 5 | 33.3 | 0.5 | 0.5 | 20.0 | 0.0 | 0.0 | 0.90 | 8 | 1 | Ni* + Ni-1 μm | 0.12 |
| 17 | 5 | 5 | 5 | 33.3 | 0.5 | 0.5 | 20.0 | 0.0 | 0.0 | 0.90 | 8 | 1 | Ni* + Ni-2 μm | 0.12 |
| 18 | 5 | 5 | 5 | 33.3 | 0.5 | 0.5 | 20.0 | 0.0 | 0.0 | 0.90 | 8 | 1 | Ni* + Ni-3 μm | 0.12 |
| 19 | 5 | 5 | 5 | 33.3 | 0.5 | 0.5 | 20.0 | 0.0 | 0.0 | 0.90 | 8 | 1 | Ni* + Ni-3 μm | 0.12 |
| 20 | 2.5 | 2 | 0.5 | 50.0 | 0.5 | 0.5 | 0.0 | 0.0 | 0.0 | 1.06 | 8 | ⅙ | Ni + Au-st | 0.1 |
| 21 | 5 | 5 | 10 | 25.0 | 0.5 | 0.5 | 20.0 | 0.0 | 0.0 | 0.90 | 8 | ½ | Ni* + Ni-2 μm | 0.12 |
| 22 | 5 | 5 | 5 | 33.3 | 0.5 | 0.0 | 20.0 | 0.0 | 0.0 | 0.40 | 8 | ⅙ | Ni + Au-st | 0.1 |
| 23 | 5 | 5 | 5 | 33.3 | 0.5 | 0.5 | 0.0 | 0.0 | 0.0 | 1.10 | 8 | ⅙ | Ni + Au-st thick | 0.1 |
| 24 | 5 | 5 | 5 | 33.3 | 0.5 | 0.5 | 20.0 | 0.0 | 0.0 | 0.75 | 8 | ½ | Ni + Au-st thick | 0.1 |
| 25 | 5 | 5 | 5 | 33.3 | 0.5 | 0.5 | 20.0 | 0.0 | 0.0 | 0.75 | 8 | 2 | Ni* + Ni-1 μm | 0.12 |
| 26 | 5 | 5 | 5 | 33.3 | 0.5 | 0.5 | 20.0 | 0.0 | 0.0 | 0.75 | 8 | ½ | Ni + Au-st thick | 0.1 |
| 27 | 5 | 5 | 5 | 33.3 | 0.5 | 0.0 | 20.0 | 0.0 | 0.0 | 0.98 | 8 | ⅙ | Ni plate | 0.1 |
| 28 | 5 | 5 | 3 | 38.5 | 0.5 | 0.5 | 0.0 | 0.0 | 0.0 | 1.06 | 8 | ⅙ | Ni + Au-st | 0.1 |
| 29 | 5 | 5 | 5 | 33.3 | 0.5 | 0.5 | 0.0 | 0.0 | 0.0 | 1.10 | 8 | 1 | Ni + Au-st thick | 0.1 |
| 30 | 5 | 5 | 3 | 38.5 | 0.5 | 0.5 | 0.0 | 0.0 | 0.0 | 1.06 | 8 | ½ | Ni plate | 0.1 |
| 31 | 5 | 5 | 3 | 38.5 | 0.5 | 0.5 | 0.0 | 0.0 | 0.0 | 1.06 | 8 | ½ | Ni + Au-st | 0.1 |
| 32 | 5 | 5 | 3 | 38.5 | 0.5 | 0.5 | 0.0 | 0.0 | 0.0 | 1.10 | 8 | ⅙ | Ni + Au-st | 0.1 |
| 33 | 5 | 5 | 5 | 33.3 | 0.5 | 0.5 | 20.0 | 0.0 | 0.0 | 0.75 | 8 | 1 | Ni* + Ni-1 μm | 0.12 |
| 34 | 5 | 5 | 5 | 33.3 | 0.5 | 0.5 | 20.0 | 0.0 | 0.0 | 0.75 | 8 | ⅙ | Ni plate | 0.1 |
| 35 | 5 | 5 | 3 | 38.5 | 0.5 | 0.5 | 0.0 | 0.0 | 0.0 | 1.06 | 8 | ½ | Ni plate | 0.1 |
| 36 | 1 | 5 | 0 | 16.7 | 0.5 | 0.5 | 20.0 | 0.0 | 0.0 | 1.12 | 8 | ⅙ | Ni + Au-st thick | 0.1 |
| 37 | 1 | 5 | 0 | 16.7 | 0.5 | 0.5 | 20.0 | 0.0 | 0.0 | 1.12 | 8 | ½ | Ni + Au-st thick | 0.1 |
| 38 | 2 | 2 | 0 | 50.0 | 0.5 | 0.5 | 20.0 | 0.0 | 0.0 | 0.74 | 8 | ⅙ | Ni + Au-st thick | 0.1 |
| 39 | 2 | 2 | 0 | 50.0 | 0.5 | 0.5 | 20.0 | 0.0 | 0.0 | 1.28 | 8 | ⅙ | Ni + Au-st thick | 0.1 |
| 40 | 10 | 4 | 0 | 71.4 | 0.5 | 0.5 | 0.0 | 0.2 | 0.3 | 1.00 | 8 | ½ | Ni plate | 0.1 |
| 41 | 2.5 | 2 | 0 | 55.6 | 0.5 | 0.5 | 0.0 | 0.0 | 0.0 | 1.00 | 8 | ⅙ | Ni + Au-st | 0.1 |
| 42 | 10 | 2 | 0 | 83.3 | 0.0 | 1.4 | 30.0 | 1.0 | 0.0 | 1.00 | 8 | ⅙ | Ni + Au-st | 0.1 |
| 43 | 2.5 | 2 | 0 | 55.6 | 0.5 | 0.5 | 0.0 | 0.0 | 0.0 | 1.06 | 8 | ⅙ | Ni plate | 0.1 |
| 44 | 2 | 2 | 0 | 50.0 | 0.5 | 0.5 | 20.0 | 0.0 | 0.0 | 1.26 | 8 | ⅙ | Ni + Au-st thick | 0.1 |
| 45 | 2.5 | 2 | 0 | 55.6 | 0.5 | 0.5 | 0.0 | 0.0 | 0.0 | 1.06 | 8 | ⅙ | Ni + Au-st | 0.1 |
| 46 | 2.5 | 3 | 0 | 45.5 | 0.5 | 0.5 | 0.0 | 0.0 | 0.0 | 1.06 | 8 | ⅙ | Ni plate | 0.1 |
| 47 | 10 | 2 | 0 | 83.3 | 0.0 | 1.4 | 30.0 | 0.5 | 0.0 | 1.00 | 8 | ⅙ | Ni plate | 0.1 |
| 48 | 5 | 5 | 0 | 50.0 | 0.5 | 0.5 | 0.0 | 0.0 | 0.0 | 1.00 | 8 | ⅙ | Ni + Au-st | 0.1 |
| 49 | 10 | 4 | 0 | 71.4 | 0.5 | 0.5 | 0.0 | 0.0 | 0.0 | 1.00 | 7 | ½ | Ni plate | 0.1 |
| 50 | 10 | 4 | 0 | 71.4 | 0.5 | 0.5 | 0.0 | 0.0 | 0.0 | 1.00 | 7 | ½ | Ni + Au-st | 0.1 |
| 51 | 10 | 4 | 0 | 71.4 | 0.5 | 0.5 | 0.0 | 0.0 | 0.0 | 1.00 | 7 | ½ | Ni plate | 0.1 |

Ni*: Ni-base superalloy

TABLE 3
Electroless Pt—Ir—Co Alloy Plating Test Result
Test Result

| | Deposition | | | | | |
|---|---|---|---|---|---|---|
| Experiment | Amount | | | | | |
| No. | mg | (1) | (2) | (3) | (4) | Determination |
| 1 | 15.2 | 8.73 | 91.16 | 0.11 | 0.925 | good |
| 2 | 62.4 | 10.23 | 89.73 | 0.04 | 2.97 | good, but textured |
| 3 | 4.1 | 14.83 | 81.04 | 4.31 | 0.22 | good |
| 4 | 2.6 | 15.61 | 79.31 | 5.08 | 0.22 | good |
| 5 | 3.2 | 15.62 | 82.59 | 1.79 | 0.245 | good |
| 6 | 2.0 | 17.28 | 79.32 | 3.40 | 0.24 | good |
| 7 | 6.6 | 19.26 | 79.22 | 1.52 | 0.43 | good |
| 8 | 16.6 | 19.6 | 80.4 | 0.00 | 1.175 | good |
| 9 | 19.0 | 20.46 | 79.54 | 0.00 | 1.22 | good |
| 10 | 8.7 | 20.62 | 79.38 | 0.00 | 0.615 | good |
| 11 | 9.3 | 21.18 | 78.37 | 0.45 | 0.735 | good |
| 12 | 18.1 | 21.19 | 78.81 | 0.00 | 1.16 | good |
| 13 | 27.4 | 23.15 | 76.85 | 0.00 | 0.405 | good |
| 14 | 8.1 | 23.19 | 76.81 | 0.00 | 0.605 | good |
| 15 | 18.3 | 23.55 | 76.23 | 0.22 | 1.115 | good |
| 16 | 23.7 | 23.7 | 71.27 | 5.03 | 1.985 | good |
| 17 | 40.8 | 25.4 | 71.6 | 0.30 | 2.44 | good |
| 18 | 75.7 | 25.85 | 72.13 | 2.02 | 3.34 | good |
| 19 | 56.8 | 29.71 | 68.02 | 2.27 | 3.11 | good |
| 20 | 10.0 | 25.72 | 74.28 | 0.00 | 0.755 | good |
| 21 | 43.9 | 25.88 | 70.56 | 3.56 | 2.53 | good |
| 22 | 14.0 | 26.16 | 73.76 | 0.08 | 1.075 | good |
| 23 | 8.7 | 26.91 | 71.96 | 1.13 | 0.625 | good |
| 24 | 12.9 | 27.26 | 72.27 | 0.47 | 0.9 | good |
| 25 | 31.9 | 28.5 | 67.54 | 3.96 | 2.34 | good |
| 26 | 47.5 | 29.48 | 70.51 | 0.01 | 2.49 | good |
| 27 | 14.3 | 27.81 | 71.57 | 0.62 | 0.97 | good |
| 28 | 12.4 | 28.5 | 71.12 | 0.38 | 0.92 | good |
| 29 | 71.1 | 28.5 | 71.4 | 0.01 | 3.26 | good |
| 30 | 20.2 | 28.51 | 71.2 | 0.29 | 1.125 | good |
| 31 | 51.5 | 28.83 | 70.03 | 1.14 | 1.035 | good |
| 32 | 15.6 | 28.88 | 70.88 | 0.24 | 1.145 | good |
| 33 | 29.6 | 30.54 | 65.87 | 3.59 | 2.795 | good |
| 34 | 17.6 | 31.32 | 68.32 | 0.36 | 1.085 | good |
| 35 | 41.8 | 32.79 | 63.05 | 4.16 | 0.265 | good |
| 36 | 24.3 | 11.53 | 88.47 | 0.00 | 1.395 | good |
| 37 | 81.6 | 12.89 | 87.11 | 0.00 | 3.465 | good |
| 38 | 3.6 | 15.05 | 84.95 | 0.00 | 0.23 | good |
| 39 | 2.5 | 15.25 | 80.75 | 0.00 | 0.225 | good |
| 40 | 13.1 | 16.37 | 83.63 | 0.00 | 0.825 | good |
| 41 | 20.3 | 21.44 | 78.56 | 0.00 | 1.345 | good |
| 42 | 8.5 | 23.12 | 76.88 | 0.00 | 0.58 | good |
| 43 | 8.1 | 23.19 | 76.81 | 0.00 | 0.605 | good |
| 44 | 17.5 | 23.32 | 76.6 | 0.00 | 1.07 | good, but textured |
| 45 | 9.5 | 24.05 | 75.95 | 0.00 | 0.765 | good |
| 46 | 13.0 | 26.69 | 73.31 | 0.00 | 0.885 | good |
| 47 | 11.6 | 27.18 | 72.82 | 0.00 | 0.72 | good |
| 48 | 15.1 | 29.6 | 70.23 | 0.00 | 1.325 | good |
| 49 | 19.6 | 30.21 | 69.79 | 0.00 | 0.86 | good |
| 50 | 21.1 | 30.79 | 69.21 | 0.00 | 1.225 | good |
| 51 | 23.9 | 32.88 | 67.21 | 0.00 | 1.37 | good |

TABLE 4
Composition Range and Thickness of Formed Film ((1) to (4)
are the numbering in Table 3.)

| | | | Thickness | Deposition |
|---|---|---|---|---|
| Ir (wt %) (1) | Pt (wt %) (2) | Co (wt %) (3) | (μm) (4) | Speed (μm/h) |
| 8.7-37.7 | 62.7-91.2 | 0.0-5.0 | 0.22-3.5 | maximum 7.6 |

### INDUSTRIAL APPLICABILITY

Regarding the application field, the invention is applicable to high-temperature structural materials that require antioxidation and high-temperature corrosion resistance, such as turbines for aircraft, gas turbine materials for thermal power systems, etc.; electrodes for electronic materials, catalysts and sensors; and as electroless, the production cost can be reduced and the method is expected as a high-yield coating method.

In addition, the invention is applicable to special catalyst in production of chemicals, or to electrodes for chemical decomposition.

In addition, as electroless plating, the substrate is not specifically restricted for the method of the invention, and the method is applicable to any flexible substrate; and the articles plated according to the method are usable as corrosion-resistant electrodes for constructions.

1. A method of electroless plating with an alloy film, which comprises contacting a substrate with a metal compound solution, and reducing the compounds to deposit metals on the surface of the substrate, and which is characterized in that the substrate is immersed in the metal compound solution prepared by dissolving a plurality of metal compounds of metals differing from each other, and an alloy film of the metals is formed on the surface of the substrate.

2. The electroless plating method with an alloy film as claimed in claim 1, wherein the pH value of the metal compound solution is lower than 5.0.

3. The electroless plating method with an alloy film as claimed in claim 1, wherein one or more of bromides, chlorides, sulfates, citric acid or its salts, oxalic acid or its salts, acetic acid or its salts, and malonic acid or its salts are mixed in the metal compound solution.

4. The electroless plating method with an alloy film as claimed in claim 1, wherein the plurality of metal compounds of metals differing from each other are compounds of Pt and Ir optionally further with compounds of one or more metals of Co, Ni, Cr, Fe and Cu.

5. The electroless plating method with an alloy film as claimed in claim 5, wherein at least one of alkali metal bromides or sulfates is mixed in the solution of metal compounds dissolved therein.

6. The electroless plating method with an alloy film as claimed in claim 4, wherein at least one of citric acid, oxalic acid and their salts is mixed in the solution of metal compounds dissolved therein.

7. A plating liquid for use in the electroless plating method of claim 1, wherein a plurality of metal compounds of metals differing from each other are dissolved therein.
